(19) United States
(12) Patent Application Publication
(10) Pub. No.: US 2025/0163755 A1
(43) Pub. Date: May 22, 2025

(54) RAIL FOR A COVERING

(71) Applicant: Hunter Douglas Industries B.V., Rotterdam (NL)

(72) Inventor: Jörg Bohlen, Langen (DE)

(21) Appl. No.: 18/841,172

(22) PCT Filed: Jan. 13, 2023
(86) PCT No.: PCT/EP2023/050727

§ 371 Date: Aug. 23, 2024

(30) Foreign Application Priority Data
Feb. 25, 2022 (GB) 2202618.1

(51) Int. Cl. E06B 9/42

(52) U.S. Cl. CPC E06B 9/42

(57) ABSTRACT

A rail for a fabric of a window covering is configured to allow the rail to be secured to an edge of the fabric easily and efficiently and to allow the rail to remain secured thereto for an extended period of time.

The present application relates to a rail for a covering, for example a bottom rail for a fabric of a an architectural opening covering such as a window covering, together with a method of fitting a fabric of a covering to such a rail.

Various coverings for windows are known, including those in which a fabric is used. In order to provide a neat finish to the distal end of a piece of fabric, it is known to secure a rail along the edge forming that distal end. Such a rail may be secured in various manners. For example, reference may be made to U.S. Pat. No. 3,970,402, NL 8802909 and GB 1,150,879.

It would be desirable to be able to secure a rail to an edge of a piece of fabric easily and efficiently, and for the rail to remain secured for an extended period of time.

According to the present invention, there is provided a rail, such as a bottom rail, for a fabric of a covering, such as an architectural opening covering, for example a window covering. The rail includes a rail profile extending elongately in a first direction and laterally in a second direction between a fabric edge and a wedge edge, the second direction being perpendicular to the first direction, and a wedge. The rail profile includes a first wall extending in the first direction and extending in the second direction between the fabric edge and the wedge edge, a second wall extending in the first direction and extending in the second direction between the fabric edge and the wedge edge, the first wall being separated from the second wall in a third direction perpendicular to the first and second directions, the first wall having an inner surface and the second wall having an inner surface, the inner surface of the first wall facing the inner surface of the second wall, and a middle wall extending in the first direction and extending from a location on the inner surface of the first wall to a location on the inner surface of the second wall. The middle wall, together with the inner surface of the first wall and the inner surface of the second wall between the middle wall and the wedge edge, may define therebetween a wedge channel for receiving the wedge, and the middle wall, together with the inner surface of the first wall and the inner surface of the second wall between the middle wall and the fabric edge, define therebetween a fabric channel for receiving a fabric of a window covering. The middle wall may be at least partially elastic and the first wall, the second wall and the middle wall may be configured such that, with the middle wall in a relaxed state, the inner surface of the first wall and the inner surface of the second wall at the fabric edge define therebetween a fabric entrance through which the fabric is able to pass into the fabric channel and the inner surface of the first wall and the inner surface of the second wall at the wedge edge define therebetween a wedge entrance to the wedge channel. The wedge may extend in an elongate direction and has a cross section along the length of the elongate direction including a triangular portion tapering from an apex to a wide portion. The middle wall may include an elongate deflection protruding in the second direction towards the fabric edge and defining the wedge channel with an extension in the second direction towards the fabric edge to accommodate the apex of the wedge when positioned within the wedge channel. The extension of the middle wall from the inner surface of the first wall to the inner surface of the second wall may include, in succession, extension in the second direction towards the fabric edge, then extension in the third direction, then extension in the second direction towards the wedge edge, thereby to provide the elongate deflection. The midpoint of the middle wall between the inner surface of the first wall and the inner surface of the second wall may be closer to the fabric edge than to the wedge edge.

This arrangement simultaneously addresses a number of conflicting requirements and provides associated benefits. By the middle wall being at least partially elastic, it allows elastic deformation of the middle wall which can provide sustained gripping of the fabric at the fabric end. By forming the middle wall with the elongate deflection, the length of the middle wall may be increased, thereby allowing a greater extent of elastic deformation for the same material properties of the middle wall. Also, the elongate deflection allows the wedge to extend further within the rail profile towards the fabric edge such that the taper of the wedge may have a smaller/shallower angle, thereby facilitating its insertion into the wedge channel through the wedge entrance. Because of the elongate deflection of the middle wall, the midpoint of the middle wall is closer to the fabric edge such that the point of rotation/pivoting of the first and second walls when the wedge is pressed into the wedge channel until the first and second walls meet at the fabric edge, is closer to the fabric edge, thereby improving/facilitating insertion of the wedge into the wedge channel.

The locations from which the middle wall extends from the inner surface of the first wall and to which the middle wall extends to the inner surface of the second wall may be closer to the wedge end than to the fabric edge.

In this way, the length of the middle wall between the first and second walls can be increased so as to allow greater elastic movement.

The locations may be spaced from the wedge edge by a length of between one quarter and one third of the distance between the wedge edge and the fabric edge.

The thickness of the middle wall may be less than the thickness of the first wall and the thickness of the second wall, such that movement of the first wall and the second wall away from each other at the wedge edge causes elastic deformation of the middle wall in preference to deflection of the first wall and the second wall.

Functionally, the wedge deflects the first and second walls away from each other at the wedge edge so as to cause the first and second walls to grip the fabric at the fabric edge. This is achieved by the elastic resilience of the rail profile. Some elastic deformation may occur in the first and second walls, thereby contributing to the gripping of the fabric. However, it may be desirable for the first and second walls to maintain a relatively fixed profile shape. In this case, it may be desirable for the first and second walls to have small or negligible elastic deformation. By choosing appropriate relative thicknesses of the middle wall and the first and second walls, it is possible to achieve substantially all of the elastic deformation in the middle wall.

The thickness of the middle wall may vary along its extension between the inner surface of the first wall and the inner surface of the second wall. For example, at the locations where the middle wall meets the first and second wall, the thickness of the middle wall may be greater, for example similar to that of the first and second walls. In this way, the elastic deformation can be directed towards a central portion of the middle wall. This will be advantageous especially when the first and second walls first pivot/rotate until they meet at the fabric end.

At the fabric edge, the first wall may include a first smooth and rounded surface for gripping one side of the fabric and the second wall may include a second smooth and rounded surface for gripping the other side of the fabric.

During assembly, a fabric is inserted through the fabric entrance into the fabric channel and then the first and second walls are deflected by the wedge until the first and second walls contact and then grip the fabric. It is desirable that the fabric maintains a flat or unwrinkled state. In this respect, any teeth at the fabric end of the first and second walls will tend to form wrinkles in the fabric. Similarly flat, or sharp edges may cause such wrinkles. By providing smooth and rounded surfaces, it is possible to first contact and then grip the fabric without forming wrinkles.

The rail profile may be formed as a single extruded component, for example from aluminium or an alloy thereof.

In one arrangement, the rail profile, with the elongate direction of the wedge parallel with the first direction of the rail profile, may be configured to receive, at a first relative position of the wedge, the apex of the wedge in the wedged entrance between the inner surface of the first wall and the inner surface of the second wall, to allow the wedge to be moved from the first relative position inwardly into the wedge channel to a second relative position so that the triangular portion rotates the first wall and the second wall about the middle wall and thereby moves the first wall and the second wall away from each other at the wedge edge and moves the first wall and the second wall towards each other at the fabric edge to close the fabric entrance and contact the fabric between the inner surface of the first wall and the inner surface of the second wall, and to allow the wedge to be moved from the second relative position further inwardly into the wedge channel to a third relative position so that the triangular portion rotates the first wall and the second wall about the fabric edge where the first and second walls contact the fabric and thereby further moves the first wall and the second wall away from each other at the wedge edge by elastically deforming the middle wall, the middle wall being configured, in the third relative position, to press resiliently the first wall and the second wall towards each other at the fabric edge so as to press upon and grip the fabric.

In this way, the rail profile and wedge allow a smooth transition from the first relative position in which the fabric is loosely positioned in the fabric channel, to the second relative position in which the first and second walls first contact either side of the fabric, and to the third relative position in which the fabric is gripped securely/firmly between the first and second walls by virtue of the elastic deformation and returning resilient force of the middle wall. This returning resilient force may be sustained for a long period of time, thereby maintaining the grip on the fabric.

The cross-section of the wedge may include, on an opposite side of the wide portion to the apex, a tapered portion which tapers inwardly in a direction away from the wide portion.

The tapered portion may be used to hold the wedge securely within the rail profile.

In one arrangement, at least with the wedge in the third relative position within the wedge channel, proximate the wedge edge, the inner surfaces of the first and second walls taper inwardly towards each other in a direction towards the wedge edge, and, with the wedge edge in the third relative position within the wedge channel, the resilient returning force of the elastic deformation of the middle wall acts to press the inner surfaces of the first and second walls against the tapered portion of the wedge so as to retain the wedge within the wedge channel in the third relative position.

In this way, the wedge is held securely within the rail profile and, because of the actions of the wedge on the first and second walls, the fabric is gripped securely at the fabric end.

In one arrangement, the rail profile may be configured to allow the wedge to be moved from the second relative position to the third relative position via an intermediate relative position at which the resilient returning force of the elastic deformation of the middle wall acts to press the inner surfaces of the first and second walls proximate the wedge edge against the wide portion of the wedge, and to allow the wedge to be moved from the intermediate relative position within the wedge channel further inwardly into the wedge channel to the third relative position, so that the tapered portion of the wedge causes the first wall and second wall to move closer to each other at the wedge edge.

Thus, as the wedge is pressed progressively into the wedge channel, the first and second walls are spread further and further apart until the wedge end of the first and second walls are at the wide portion of the wedge. Beyond this point, the wedge end of the first and second walls move inwardly towards each other by a small amount corresponding to the taper of the tapered portion of the wedge. The tapered portion of the wedge is thus arranged to taper inwardly by a small amount which does not affect significantly the grip on the fabric, but is enough to secure the wedge within the wedge channel.

In one arrangement, the wedge may include a base, the tapered portion extending between the base and the wide portion. The base may include, on each opposite side of the cross-section, a respective ledge extending in the elongate direction and protruding beyond the tapered portion by the thickness of the respective first and second wall such that, with the wedge in the third relative position within the wedge channel, the first and second walls form respective flush surfaces with the respective ledges.

In this way, the assembly of the wedge in the rail profile is aesthetically pleasing. Furthermore, the interface between the wedge and the rail profile is smooth and not prone to catching on any other components.

In some arrangements, the base may include further decorative or functional features, such as components for abutting against an architectural opening surround.

According to the present invention, there is also provided a method of fitting a fabric of a covering to a rail as defined above. The method further includes inserting an edge of the fabric through the fabric entrance of the rail profile and positioning the edge of the fabric within the fabric channel such that the fabric extends through the fabric entrance, positioning the wedge in the first relative position with the apex of the wedge in the wedge entrance between the inner surface of the first wall and the inner surface of the second wall of the rail profile, and pressing the wedge in the second direction of the rail profile towards the fabric edge so as to move the wedge from the first relative position to the second relative position thereby rotating the first and second walls about the middle wall until the fabric entrance is closed and the fabric is contacted and held between the first and second walls, and so as then to move the wedge from the second relative position to the third relative position thereby rotating the first and second walls about the fabric edge where the first and second walls contact the fabric whilst elastically deforming the middle wall so that the middle wall provides the resilient returning force to grip the fabric between the first and second walls at the fabric edge.

Thus there is provided a simple and efficient method for securing a rail to a fabric. No additional fasteners are required. The ongoing resilient returning force of the middle wall ensures that the fabric is secured over an extended period of time.

When used with a wedge having the tapered portion, the method may be such that, when the wedge is moved from the second relative position to the third relative position, the wedge moves via an intermediate relative position at which the resilient returning force of the elastic deformation of the middle wall acts to press the inner surfaces of the first and second walls proximate the wedge edge against the wide portion of the wedge. The method may include moving the wedge from the intermediate relative position within the wedge channel further inwardly into the wedge channel to the third relative position so that the tapered portion of the wedge causes the first wall and second wall to move closer to each other at the wedge edge.

In this way, the method also ensures that the wedge is securely held in place in the rail profile.

The invention will be more clearly understood from the following description, given by way of example only, with reference to the accompanying drawings, in which:

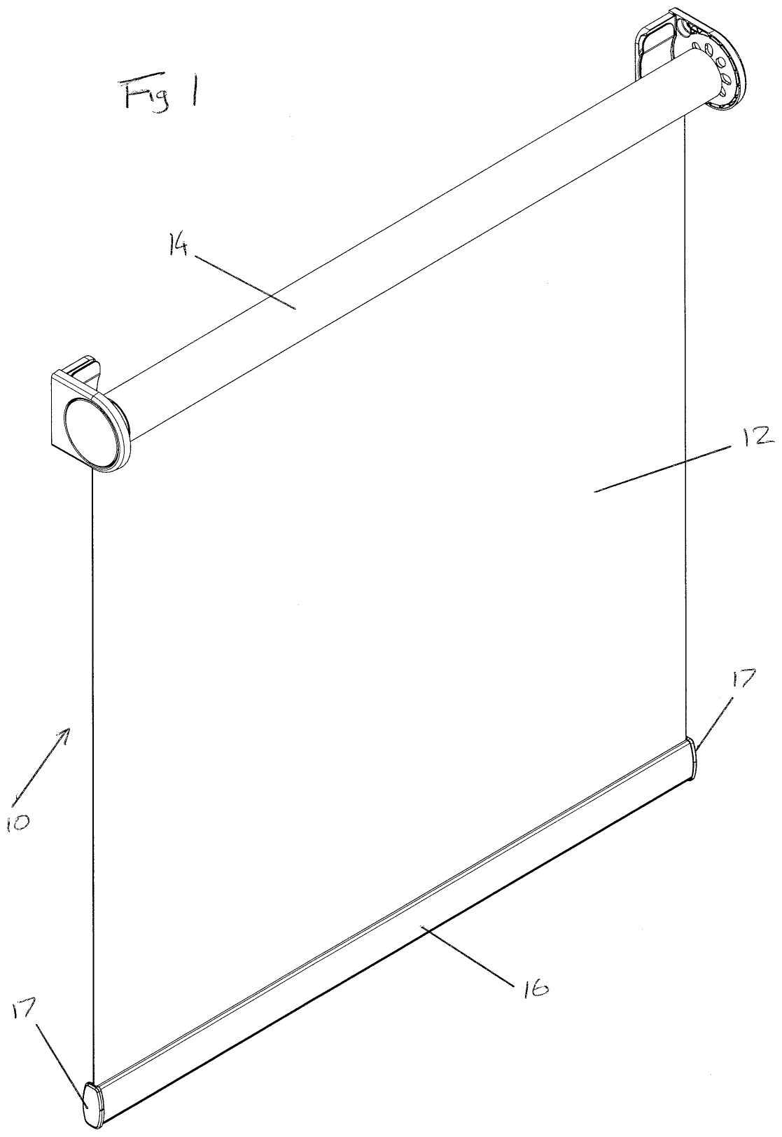

FIG. 1 illustrates a window covering including a rail embodying the present invention;

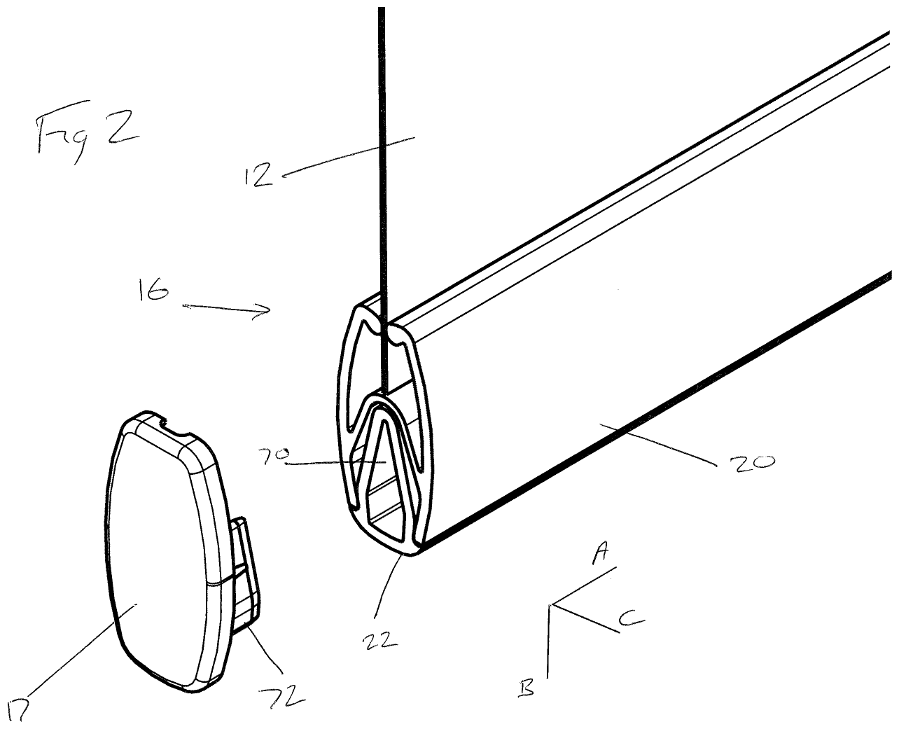

FIG. 2 illustrates the end of a rail embodying the present invention:

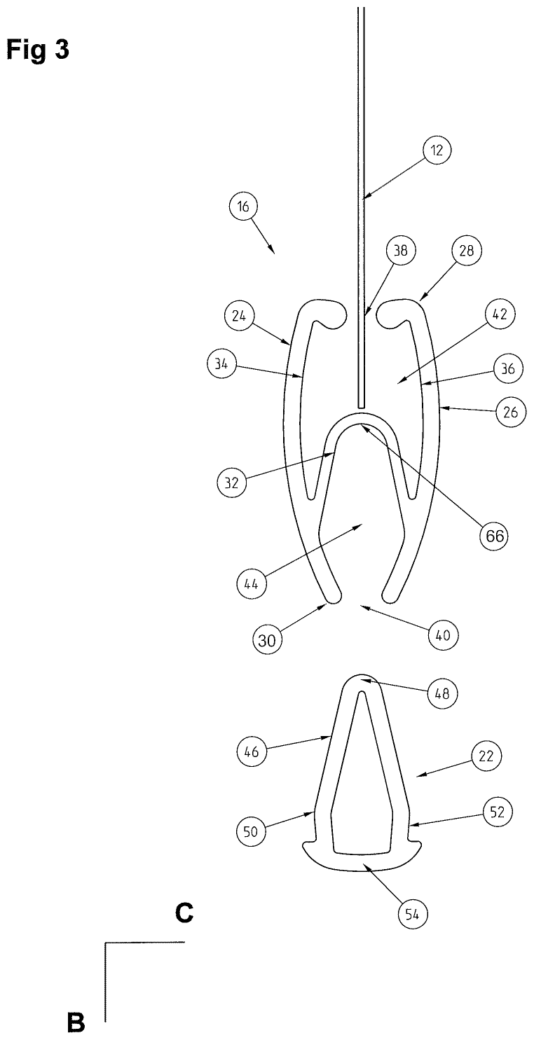

FIG. 3 illustrates a cross-section of the rail:

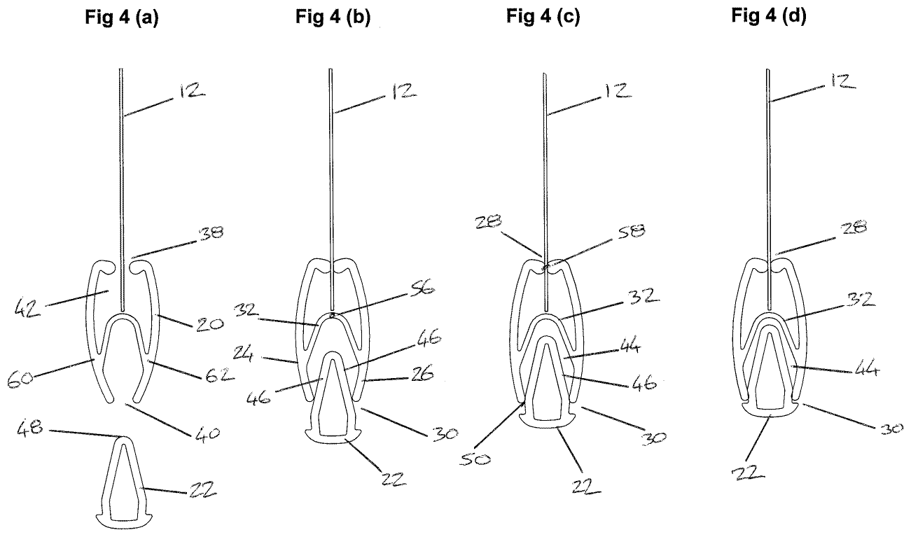

FIGS. 4 (a) to (d) illustrates steps of clamping a fabric in the rail;

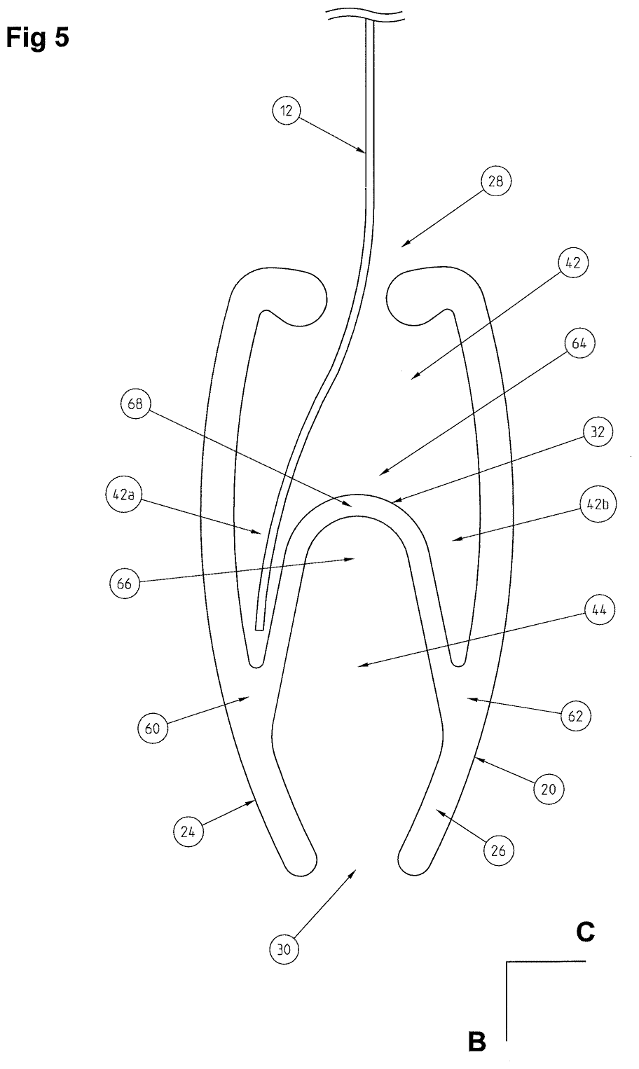

FIG. 5 illustrates details of the rail profile of the rail:

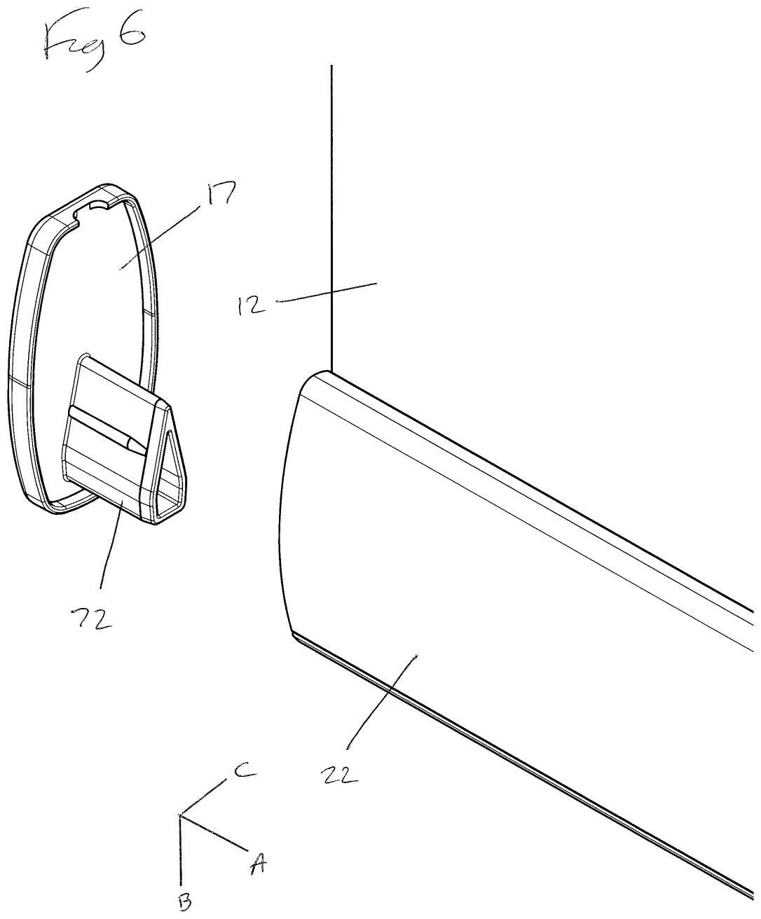

FIG. 6 illustrates details of an end cap:

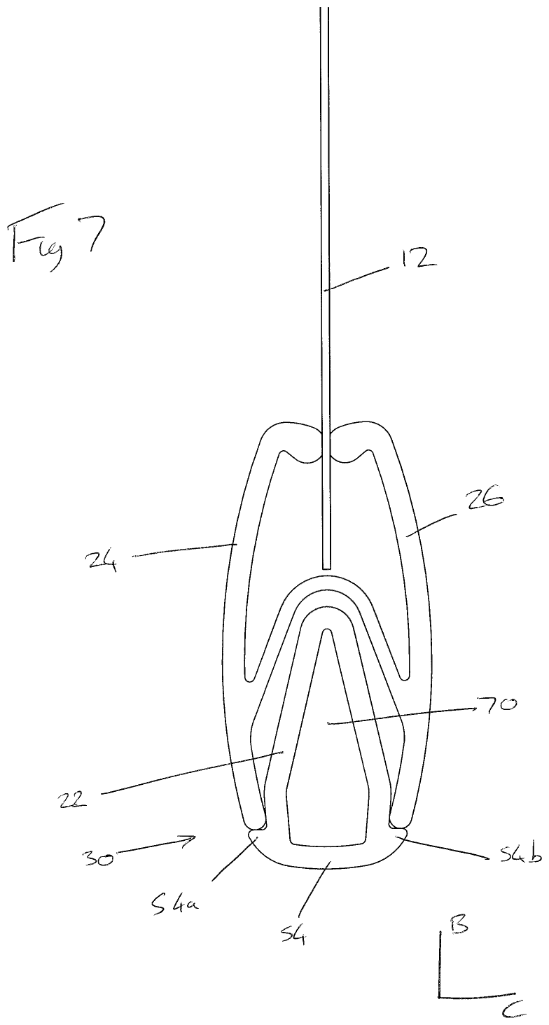

FIG. 7 illustrates a cross-section of the rail:

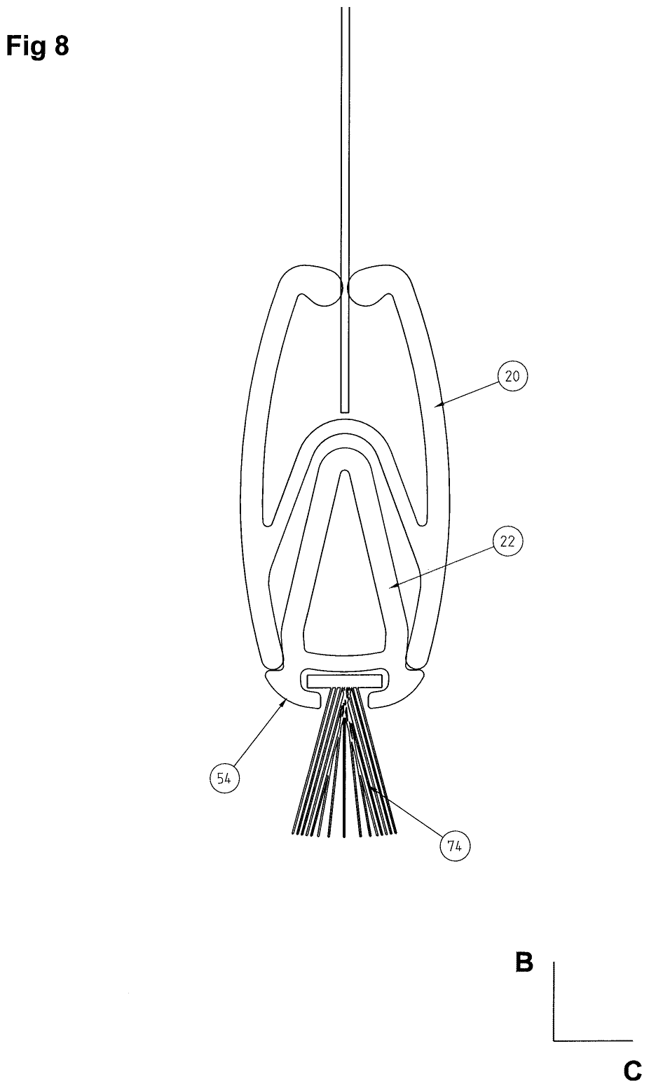

FIG. 8 illustrates a cross-section of the rail with an alternative wedge; and

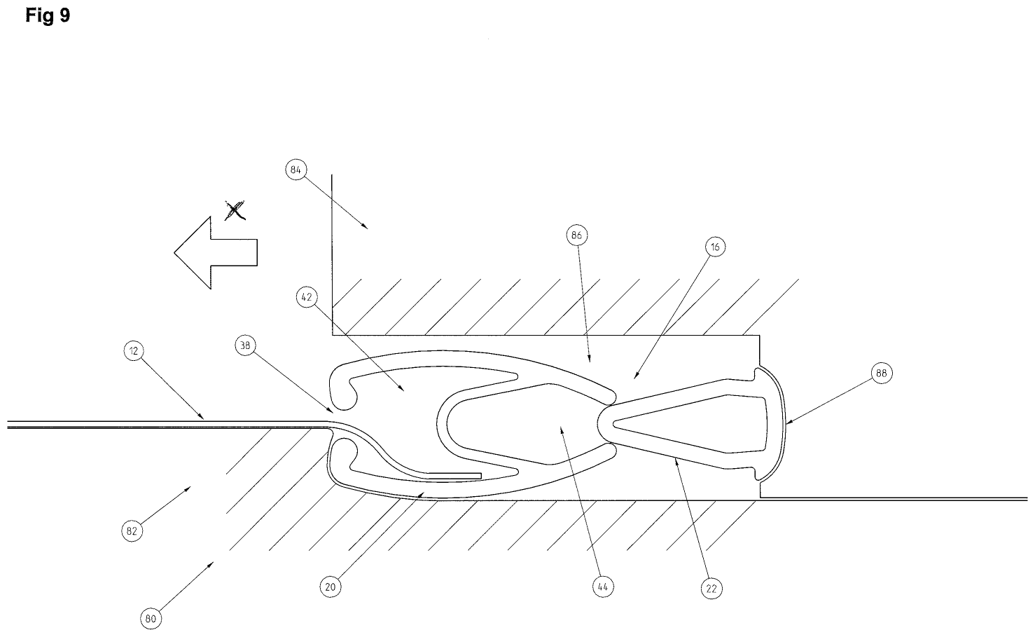

FIG. 9 illustrates an apparatus for assembling the rail.

Various blinds and coverings are known for architectural openings such as windows. Such coverings often include fabrics. It is sometimes desirable to provide a rail along one edge of such a fabric.

FIG. 1 illustrates an example of a window covering 10 including a fabric 12 and a roller 14 as part of a roller blind. The fabric 12 may be extended from and retracted back onto the roller 14 so as to cover selectively an architectural opening. The distal edge of the fabric 12, as illustrated, is provided with a rail 16 according to the present invention.

A portion of the rail 16 is illustrated in greater detail in FIG. 2. The rail 16 includes a rail profile 20 and a wedge 22. As will be described in greater detail below, the wedge 22 is fitted within the rail profile 20 and acts to resiliently deform the rail profile 20 so that the rail profile 20 grips the fabric 12.

As illustrated, the rail profile 20 extends elongately in a first direction A and laterally in a second direction B. It also has a depth in a third direction C. Similarly, the wedge 22 extends in an elongate direction which, when the wedge 22 is fitted to the rail profile 20, also extend in the first direction A.

Both the rail profile 20 and the wedge 22 may be formed/manufactured in any known manner using any appropriate material. However, for the illustrated arrangement, it is desirable to form the rail profile as a single extruded component from aluminium or an alloy thereof. Similarly, the wedge 22 may be formed as a single extruded component of aluminium or an alloy thereof.

An end cap 17 may be provided for fitment to each end of the rail 16. As will be discussed below, this may be secured to the end of the wedge 22.

Further details of the rail profile 20 and the wedge 22 will be discussed with reference to cross sections through the rail profile 20 and the wedge 22.

As illustrated in FIG. 3, the rail profile 20 includes a first wall 24 and a second wall 26. The first wall 24 and the second wall 26 both extend not only elongately in the first direction A, but also laterally in the second direction B. In particular, the rail profile 20 has a fabric edge 28 and a wedge edge 30 and the first wall 24 and the second wall 26 extend laterally in the second direction B between the fabric edge 28 and the wedge edge 30.

The first wall 24 and the second wall 26 are connected by a middle wall 32. The first wall 24 has an inner surface 34 and the second wall 26 has an inner surface 36. As illustrated, the middle wall 32 extends between the inner surface 34 of the first wall 26 and the inner surface 36 of the second wall 26. Although it would be enough to provide one or more such middle walls 32 at various locations along the elongate length of the rail profile 20, in the illustrated arrangement, which is formed as an extrusion, the middle wall 32 extends elongately along the entire length of the rail profile 20 in the first direction A. It also extends generally in the third direction C between the facing inner surfaces 34, 36 of the first and second walls 24, 26. In this way, the first and second walls 24, 26 are secured to each other by means of the middle wall 32 but separated from one another in the third direction C.

The rail profile 20, especially the middle wall 32, is resiliently deformable. This will be discussed in greater detail below. However, in the relaxed state as illustrated in FIG. 3, the first and second walls 24, 26 are spaced apart at the fabric edge 28 and spaced apart at the wedge edge 30. In particular, as illustrated, in the relaxed state, the first and second walls 24, 26 define, at the fabric edge 28, a fabric entrance 38, and define, at the wedge edge 30, a wedge entrance 40.

Inside the rail profile 20, the middle wall 32 on the side of the fabric edge and the inner surfaces 34, 36 of the first and second walls 24, 26 define a fabric channel 42. Similarly, the middle wall 32 on the side of the wedge edge and the inner surfaces 34, 36 of the first and second walls 24, 26 define a wedge channel 44.

The fabric entrance 38 provides an entrance into the fabric channel 42. Similarly, the wedge entrance 40 provides an entrance to the wedge channel 44.

As illustrated, in the relaxed state, with the first and second walls 24, 26 spaced apart at the fabric edge 28 so as to provide the fabric entrance 38, it is possible easily to insert the edge of the fabric 12 through the fabric entrance 38 and into the fabric channel 42.

The wedge 22 includes a triangular portion 46 which tapers from an apex 48 to a wide portion 50. The wedge 22 also includes, on an opposite side of the wide portion 50 to the apex 48, a tapered portion 52 which tapers inwardly in a direction away from the wide portion 50. The wedge 22 also includes a base 54. As illustrated, the tapered portion 52 extends between the base 54 and the wide portion 50. In particular, the width of the wedge 22 in the third direction C increases slightly between the location where the tapered portion 52 joins the base 54 and the wide portion 50.

Use of the rail 16, in particular how the wedge 22 is fitted to the rail 20 so as to secure the fabric 12, will now be described below.

As illustrated in FIG. 4 (a), with the same arrangement as illustrated in FIG. 3, the bottom rail 20 is in the relaxed state and the wedge 22 is brought into alignment with the rail profile 20. In particular, the elongate direction of the wedge 22 is oriented in the first direction A and the apex 48 is positioned adjacent or just inside the wedge entrance 40 to the wedge channel 44. This will be described as the first relative position.

Also, as noted above, in this relaxed state of the rail profile 20, it is possible to insert the edge of the fabric 12 through the fabric entrance 38 into the fabric channel 42.

As illustrated in FIG. 4 (a), the fabric 12 is inserted in a straight path only as far as meeting the middle wall 32. However, as will be discussed below, the fabric 12 could be inserted further inside the fabric channel 42 along an inner surface 34,36 of one of the first and second walls 24, 26.

By pressing the wedge 22 in the second direction B towards the fabric edge 28, as illustrated in FIG. 4 (b), the apex 48 of the wedge 22 is moved inwardly of the wedge channel 44 and the inner surfaces of the first and second walls 24, 26 are forced along the tapered portion 46 of the wedge 22. As the first and second walls 24, 26 at the wedge end 30 traverse the outer surface of the tapered portion 46, the first and second walls 24, 26 at the wedge end 30 are forced away from each other by the wedge 22.

In the illustrated arrangement, the middle wall 32 is more flexible than the first and second walls 24, 26. For example, in the illustrated arrangement, where the rail portion 20 is formed as a single extrusion, the middle wall 32 is less thick than the first and second walls 24, 26. As a result, when the first and second walls 24, 26 are forced away from each other at the wedge end 30, the first and second walls 24, 26 pivot around a point 56 in the middle wall 32 midway between the first and second walls 24, 26 in the third direction C. This deflection and pivoting of the first and second walls 24, 26 continues until the rail portion 20 and wedge 22 reach a second relative position at which the first wall 24 and second wall 26 contact either respective side of the fabric 12. With the first and second walls 24, 26 abutting each other via the fabric 12 at the fabric end 28 of the rail profile 20, further pivoting of the first and second walls 24, 26 around the point 56 is no longer possible.

Pressing the wedge 22 further inwardly into the wedge channel 44 causes the ends of the first and second walls 24, 26 at the wedge end 30 to continue to traverse the outer surface of the tapered portion 46 of the wedge 22. As a result, of course, the ends of the first and second walls 24, 26 at the wedge end 30 are forced further outwardly away from each other. Noting, as above, that the first and second walls 24, 26 can no longer pivot around point 56 in the middle wall 32, the first and second walls 24, 26 now pivot about the point 58 at which the ends of the first and second walls 24, 26 at the fabric end press onto either respective side of the fabric 12. In order for this rotation/deflection to occur, the middle wall 32 is resiliently deformed. In particular, the locations 60, 62 where the middle wall 32 joins with the inner surfaces 34, 36 of the first and second walls 24, 26 are moved away from each other as the first and second walls 24, 26 pivot about the point 58. This resilient deformation of the middle wall 32 creates a restoring resilient force in the middle wall 32 which acts to press together the first and second walls 24, 26 at the fabric end 28 and, thereby, grip either side of the fabric 12 with that restoring resilient force. FIG. 4 (c) illustrates this situation where the ends of the first and second walls 24, 26 are at the wide portion 50 of the wedge 22.

Merely for the purpose of securely gripping the fabric 12, the relative position illustrated in FIG. 4 (c) would achieve the required result. However, the illustrated arrangement includes a wedge 20 which, as described above, includes a tapered portion 52 which tapers inwardly from the wide portion 50 towards the base 54.

By pressing the wedge 22 yet further into the wedge channel 44, the inner surfaces 34, 36 of the first and second walls 24, 26 traverse beyond the wide portion 50 of the wedge 22 along the tapered portion 52. Along the tapered portion 52, the ends of the first and second walls 24, 26 move slightly inwardly towards one another. As a result, the resilient restoring force in the middle wall 32 is slightly reduced and the gripping force of the first and second walls 24, 26 on the fabric 12 at the fabric end 28 is also slightly reduced. However, the rail profile 20 and wedge 22 are configured such that even this reduced gripping force is sufficient and appropriate for gripping the fabric 12. It will be appreciated that, as a result of the tapered portion 52, in order to remove the wedge 22 from the wedge channel 44, it would be necessary to spread apart the first and second walls 24, 26 at the wedge end 30, against the resilient restoring force of the middle wall 32. Hence, in the relative position illustrated in FIG. 4 (d), the resilient restoring force of the middle wall 32 acts to retain the wedge 22 in the wedge channel 44.

Any of the relative positions between those illustrated in FIG. 4 (c) and FIG. 4 (d) can be considered as a third relative position in which resilient restoring force of the middle wall 32 provides a gripping force on the fabric 12 with the ends of the first and second walls 24, 26 at the fabric end 28. Furthermore, if the relative position illustrated in FIG. 4 (d) is considered as a final third relative position, then the relative position illustrated in FIG. 4 (c) can be considered as an intermediate third relative position.

With the arrangement as explained above, the rail profile, by means of the middle wall 32, is able to maintain a gripping force on the fabric 12 over an extended period of time even if the resilient restoring force of the middle wall 32 itself diminishes somewhat as a result of creep and such like.

There are some other important features to note in the illustrated arrangement as discussed above. For example, it will be seen that, at the wedge end 28, the ends of the first and second walls 24, 26 are formed as smooth and rounded surfaces. Although it would be possible to provide the ends of the first and second walls 24, 26 with teeth or edges for biting into the respective surfaces of the fabric 12, smooth and rounded surfaces have advantages. In particular, during the process of contacting and then gripping the fabric 12 in the second and third relative positions described above with reference to FIGS. 4 (b) to (d), teeth or sharp edges can have the effect of forming wrinkles in the fabric 12. By providing a smooth and rounded surface on the end of each of the first and second walls 24, 26 respectively, the fabric 12 can be contacted and then gripped without the formation of undesirable wrinkles.

As discussed above, the middle wall 32 provides a bridge between the first and second walls 24, 26 separated in the third direction C. However, the shape and position of the middle wall 32 is of significance. As will be described with reference to FIG. 5, the middle wall 32 connects with the first wall 24 at the first location 60 and connects with the second wall 26 at the second location 62. In particular, the middle wall 32 extends away from the inner surface 34 of the first wall 24 at the location 60 across the space between the first and second walls 24, 26, and to the inner surface 36 of the second wall 26, joining the second wall 26 at the second location 62.

The middle wall includes a deflection 64 running along the elongate extent of the rail profile 20 and protruding in the second direction B towards the fabric edge 28. This results in a wedge channel 44 with an extension 66 in the second direction B towards the fabric edge 28. As illustrated especially in FIG. 4 (d), this extension 66 accommodates the apex 48 of the wedge 22 when the wedge 22 is positioned within the wedge channel 44. As a result, it becomes possible to use a wedge 22 having a longer extent in the second direction B. With a longer extent in the second direction B, a shallower taper may be provided on the tapered section 46 of the wedge 22. As a result, as the wedge 22 is pressed inwardly into the wedge channel 44, the ends of the first and second walls 24, 26 at the wedge end 30 are more gradually forced apart from one another. This facilitates and improves the construction/assembly process.

The elongate deflection 64 of the middle wall 32 also enables the location 60, 62 where the middle wall 32 joins the first and second walls 24, 26 respectively to be positioned towards the wedge end 32 of the rail profile 20.

As illustrated, considering the path of the middle wall 32 from the first location 60 to the second location 62, the middle wall first extends not only in the third direction C towards the second wall 26, but also in the second direction B towards the fabric edge 28.

It then extends in the third direction C towards the second wall 26. It then extends not only in the third direction C towards the second wall 26, but also in the second direction B towards the wedge edge 30 and the second location 62. In the illustrated arrangement, this is a continuous path forming a curved or arcuate middle wall.

By providing the locations 60, 62 towards the wedge end 32 and providing the middle wall 32 with the elongate deflection 64, the length of the middle wall 32 between the first location 60 and the second location 62 and the first wall 24 and the second wall 26 is increased as compared with a wall which extends directly in the third direction C between the first wall 24 and the second wall 26. At the same time, the middle wall 32 provides the extension 66 in the wedge channel 44 for accommodating the apex 48 of the longer wedge 22. The additional length of the middle wall 32 allows greater movement of the middle wall 32 during its elastic deformation for the same given properties of the material of the middle wall 32.

The mid-point 68 of the middle wall 32 from the inner surface of the first wall 24 to the inner surface of the second wall 26 in the illustrated arrangement is closer to the fabric edge 28 than to the wedge edge 30. This mid-point 68 corresponds to the point 56, as described with reference to FIG. 4 (b), in the middle wall 32 midway between the first and second walls 24, 26. As a result, improved pivoting of the first and second walls 24, 26 is achieved when moving between the first relative position and the second relative position as discussed above. The first and second locations 60 and 62 are preferably closer to the wedge edge 30 than to the fabric edge 28. In some arrangements, these locations 60, 62 may be spaced from the wedge edge 30 by a length of between one quarter and one third of the distance between the wedge edge 30 and the fabric edge 28.

As illustrated, noting that the locations 60, 62 are towards the wedge edge 30 and the elongate deflection 64 extends towards the fabric edge 28, the fabric channel 42 is formed with elongate pockets 42a and 42b on either side of the elongate deflection 64 between the middle wall 32 and the inner surfaces 34, 36 of the respective first and second walls 24, 26. In this respect, as illustrated in FIG. 5, it is possible to insert the fabric 12 into the fabric channel 42 such that its edge is accommodated within one of these pockets 42a, 42b.

The middle wall 32 may have a generally constant thickness along its path between the first wall 24 and the second wall 26, perhaps with a slight thickening at the first and second locations 60, 62. Alternatively, it is possible for the thickness of the wall 32 to be varied along this path so as to promote elongate deflection at particular places. For example, it may be desirable to thin the middle wall 32 towards its mid-point 68.

As noted above with reference to FIGS. 1 and 2, it may be desirable to provide respective end caps 17 for covering the open ends of the rail profile 20 and the wedge 22. In this respect, the wedge 22 may include an internal configuration 70 for receiving a part 72 of an end cap 17, for example inserted resiliently in the first direction A within the wedge 22. This part 72 of the end cap 17 is further illustrated in FIG. 6.

FIG. 7 illustrates a further feature of the base 54. In particular, the base 54 includes at each opposite side in the third direction C a respective ledge 54a and 54b. A first ledge 54a extends outwardly from the base 54 in the third direction C by an extent matching the thickness of the first wall 24 at least at the wedge end 30. Similarly, a second ledge 54b extends outwardly in the third direction from the base 54 by an extent matching the thickness of the second wall 26 at least at the wedge end 30. In this way, as illustrated in FIG. 7 (and FIG. 4 (d) above), a smooth outer profile may be provided at the wedge end of the rail 16. The first and second walls 24, 26 form respective flush surfaces with the first and second ledges 54a, 54b leading into the base 54.

The base 54 of the wedge 22 need not only have a smooth outer surface as described above. The base 54 may be configured to receive and/or support other components. For example, in the arrangement as illustrated in FIG. 8, the base 54 includes a lipped channel elongate in the first direction A for receiving a brush or rubber seal 74.

FIG. 9 illustrates schematically an apparatus for use in implementing a method of fitting a fabric 12 to a rail 16 as discussed above.

The apparatus includes a base 80 for supporting the rail profile 20. At one edge, the base 80 includes a raised portion 82 having a height of approximately half the width of the rail profile 20 (in the third direction C as described above). In this way, the raised portion 82 supports the fabric 12 as it passes through the fabric entrance 38 into the fabric channel 42. The apparatus includes a pressing component 84 slidable relative to the base 80 in the direction X. The pressing component 84 includes a cutaway 86 having a height matching the full width of the rail profile 20 in the third direction C such that, with the pressing component 84 resting on the base 80, the rail profile 20 fits closely in the gap formed by the cutaway 86 between the pressing component 84 and the base 80. The cutaway 86 also has a length in the direction X at least able to accommodate both the rail portion 20 and the wedge 22 when in the first relative position as illustrated in FIG. 9. By sliding the pressing component 84 over the base 80 in the X direction such that the back wall 88 of the cutaway 86 moves towards the raised portion 82, the back wall 88 presses the wedge 22 into the wedge channel 44 so as to carry out the method of fitting as described above with reference to FIGS. 4 (a) to (d).

By using an apparatus such as illustrated schematically in FIG. 9 which extends in the first direction A along the entire length of both the rail profile 20 and the wedge 22, it is ensured that the wedge 22 is pressed evenly into the rail profile 20. It ensures that the fabric entrance 38 is closed simultaneously along its entire length such that the fabric 12 is gripped evenly along its entire length simultaneously and without wrinkling.

1. A rail for a fabric of a covering, the rail including:
a rail profile extending elongately in a first direction and laterally in a second direction between a fabric edge and a wedge edge, the second direction being perpendicular to the first direction; and
a wedge; wherein:
the rail profile includes:
a first wall extending in the first direction and extending in the second direction between the fabric edge and the wedge edge;
a second wall extending in the first direction and extending in the second direction between the fabric edge and the wedge edge, the first wall being separated from the second wall in a third direction perpendicular to the first and second directions, the first wall having an inner surface and the second wall having an inner surface, the inner surface of the first wall facing the inner surface of the second wall; and
a middle wall extending in the first direction and extending from a location on the inner surface of the first wall to a location on the inner surface of the second wall; wherein:
the middle wall, together with the inner surface of the first wall and the inner surface of the second wall between the middle wall and the wedge edge, define therebetween a wedge channel for receiving the wedge, and the middle wall, together with the inner surface of the first wall and the inner surface of the second wall between the middle wall and the fabric edge, define therebetween a fabric channel for receiving a fabric of a covering;
the middle wall is at least partially elastic and the first wall, the second wall and the middle wall are configured such that, with the middle wall in a relaxed state, the inner surface of the first wall and the inner surface of the second wall at the fabric edge define therebetween a fabric entrance through which the fabric is able to pass into the fabric channel and the inner surface of the first wall and the inner surface of the second wall at the wedge edge define therebetween a wedge entrance to the wedge channel;
the wedge extends in an elongate direction and has a cross section along the length of the elongate direction including a triangular portion tapering from an apex to a wide portion;
the middle wall includes an elongate deflection protruding in the second direction towards the fabric edge and defining the wedge channel with an extension in the second direction towards the fabric edge to accommodate the apex of the wedge when positioned within the wedge channel;
the extension of the middle wall from the inner surface of the first wall to the inner surface of the second wall includes, in succession, extension in the second direction towards the fabric edge, then extension in the third direction, then extension in the second direction towards the wedge edge, thereby to provide the elongate deflection; and
the midpoint of the middle wall between the inner surface of the first wall and the inner surface of the second wall is closer to the fabric edge than to the wedge edge.

2. A rail according to claim 1, wherein said locations from which the middle wall extends from the inner surface of the first wall and to which the middle wall extends to the inner surface of the second wall are closer to the wedge edge than to the fabric edge.

3. A rail according to claim 2, wherein said locations from which the middle wall extends from the inner surface of the first wall and to which the middle wall extends to the inner surface of the second wall are spaced from the wedge edge by a length of between one quarter and one third of the distance between the wedge edge and the fabric edge.

4. A rail according to claim 1, wherein the thickness of the middle wall is less than the thickness of the first wall and the thickness of the second wall, such that movement of the first wall and the second wall away from each other at the wedge edge causes elastic deformation of the middle wall in preference to deflection of the first wall and the second wall.

5. A rail according to claim 4, wherein the thickness of the middle wall varies along its extension between the inner surface of the first wall and the inner surface of the second wall.

6. A rail according to claim 1, wherein, at the fabric edge, the first wall includes a first smooth and rounded surface for gripping one side of the fabric and the second wall includes a second smooth and rounded surface for gripping the other side of the fabric.

7. A rail according to claim 1, wherein the rail profile is a single extruded component.

8. A rail according to claim 1, wherein the rail profile is aluminium or an alloy thereof.

9. A rail according to claim 1, wherein the rail profile, with the elongate direction of the wedge parallel with the first direction of the rail profile, is configured: to receive, at a first relative position of the wedge, the apex of the wedge in the wedged entrance between the inner surface of the first wall and the inner surface of the second wall; to allow the wedge to be moved from the first relative position inwardly into the wedge channel to a second relative position so that the triangular portion rotates the first wall and the second wall about the middle wall and thereby moves the first wall and the second wall away from each other at the wedge edge and moves the first wall and the second wall towards each other at the fabric edge to close the fabric entrance and contact the fabric between the inner surface of the first wall and the inner surface of the second wall; and to allow the wedge to be moved from the second relative position further inwardly into the wedge channel to a third relative position so that the triangular portion rotates the first wall and the second wall about the fabric edge where the first and second walls contact the fabric and thereby further moves the first wall and the second wall away from each other at the wedge edge by elastically deforming the middle wall, the middle wall being configured, in the third relative position, to press resiliently the first wall and the second wall towards each other at the fabric edge so as to press upon and grip the fabric.

10. A rail according to claim 1, wherein:
the cross-section of the wedge includes, on an opposite side of the wide portion to the apex, a tapered portion which tapers inwardly in a direction away from the wide portion.

11. A rail according to claim 10, wherein:
at least with the wedge in the third relative position within the wedge channel, proximate the wedge edge, the inner surfaces of the first and second walls taper inwardly towards each other in a direction towards the wedge edge; and
with the wedge edge in the third relative position within the wedge channel, the resilient returning force of the elastic deformation of the middle wall acts to press the inner surfaces of the first and second walls against the tapered portion of the wedge so as to retain the wedge within the wedge channel in the third relative position.

12. A rail according to claim 11, wherein;
the rail profile is configured to allow the wedge to be moved from the second relative position to the third relative position via an intermediate relative position at which the resilient returning force of the elastic deformation of the middle wall acts to press the inner surfaces of the first and second walls proximate the wedge edge against the wide portion of the wedge, and to allow the wedge to be moved from the intermediate relative position within the wedge channel further inwardly into the wedge channel to the third relative position, so that the tapered portion of the wedge causes the first wall and second wall to move closer to each other at the wedge edge.

13. A rail according to claim 10, wherein:
the wedge includes a base and the tapered portion extends between the base and the wide portion; and
the base includes, on each opposite side of the cross-section, a respective ledge extending in the elongate direction and protruding beyond the tapered portion by the thickness of the respective first and second wall such that, with the wedge in the third relative position within the wedge channel, the first and second walls form respective flush surfaces with the respective ledges.

14. A method of fitting a fabric of a covering to a rail according to claim 1, the method including:
inserting an edge of the fabric through the fabric entrance of the rail profile and positioning the edge of the fabric within the fabric channel such that the fabric extends through the fabric entrance;
positioning the wedge in the first relative position with the apex of the wedge in the wedge entrance between the inner surface of the first wall and the inner surface of the second wall of the rail profile; and
pressing the wedge in the second direction of the rail profile towards the fabric edge so as to move the wedge from the first relative position to the second relative position thereby rotating the first and second walls about the middle wall until the fabric entrance is closed and the fabric is contacted and held between the first and second walls, and so as then to move the wedge from the second relative position to the third relative position thereby rotating the first and second walls about the fabric edge where the first and second walls contact the fabric whilst elastically deforming the middle wall so that the middle wall provides the resilient returning force to grip the fabric between the first and second walls at the fabric edge.

15. A method according to claim 14, wherein the cross-section of the wedge includes, on an opposite side of the wide portion to the apex, a tapered portion which tapers inwardly in a direction away from the wide portion, wherein, when the wedge is moved from the second relative position to the third relative position, the wedge moves via an intermediate relative position at which the resilient returning force of the elastic deformation of the middle wall acts to press the inner surfaces of the first and second walls proximate the wedge edge against the wide portion of the wedge, the method including moving the wedge from the intermediate relative position within the wedge channel further inwardly into the wedge channel to the third relative position so that the tapered portion of the wedge causes the first wall and second wall to move closer to each other at the wedge edge.
